(19) United States
(12) Patent Application Publication
(10) Pub. No.: US 2017/0241756 A1
(43) Pub. Date: Aug. 24, 2017

(54) Insight - Arrow Game Tracker

(71) Applicants: Frederick A. White, JR., Lock Haven, PA (US); Tracey L. White, Lock Haven, PA (US)

(72) Inventors: Frederick A. White, JR., Lock Haven, PA (US); Tracey L. White, Lock Haven, PA (US)

(21) Appl. No.: 15/049,046

(22) Filed: Feb. 20, 2016

(51) Int. Cl. F42B 12/38; F42B 12/36; G01S 19/19; F42B 6/04

(52) U.S. Cl. CPC F42B 12/385; F42B 6/04; F42B 12/362; G01S 19/19

(57) ABSTRACT

This invention relates to an game tracking arrow that includes an arrowhead having a tail end, a hollow shaft having a forward end and a rear end, a nock having a front end configured at rear end of the hollow shaft and a back end configured to engage a bowstring, and a tracking device having a first end configured at tail end of the arrow head and a second end configured at forward end of the hollow shaft. Further, the tracking device is adapted to transmit a tracking signal to a receiving device via wireless communication such as satellite communication, internet, Wide area network (WAN), telecommunications network and the like.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates generally to tracking devices and, more particularly, to a hunting arrow locating system using a transmitter in the arrow and a transceiver in combination with a GPS positioning system for monitoring and relaying radio frequency signals from a battery powered microchip carried in the hunting arrow to provide a hunter with information as to the location of the arrow during hunting.

(2) Background of the Invention

Hunting with a bow and arrow is a popular sport. After an arrow has been shot from the bow, it is often difficult to locate, whether it hits its target or not. If the arrow misses the target, it often disappears into the brush. If the arrow hits a target animal, such as a deer, the animal is often able to run quite a distance before it collapses as it succumbs to its wound. In such a case, it is often difficult to locate the wounded animal. In the first case, it would be desirable to locate and recover the missing arrow. In the second case, it would be desirable to locate the missing game as well as recover the missing arrow. Further, the loss of arrows is a matter of some expense which the hunter would like to avoid. In the latter case, the loss of a wounded animal is not only disappointing to the hunter, but may be harmful to the environment. It is certainly wasteful, and quite possibly dangerous.

Conventionally, radio transmitting devices have been used for tracking other devices on which the transmitting devices have been mounted. When the transmitting device is transported from place to place, its location can be discovered by an operator following the transmitting device with a receiver capable of indicating the relative strength of the received signal. As the operator with the receiver comes closer to the transmitting device, the strength of the received signal increases. As the operator modifies his direction of travel in such a manner as to continually increase the indication of the strength of the received signal, the operator can eventually discover the location of the transmitting device and, with it, the transporting means on which transmitting device was mounted.

Further, Tracking devices may be used to observe object movement. One example of a tracking device is a Global Positioning System (GPS). A GPS is a satellite-based navigation system which includes 24 satellites which were originally placed into orbit by the United States Department of Defense. Since the early 1980s, GPS has been made available for civilian use and GPS devices have proliferated and are included in many consumer devices such as vehicle navigation systems and portable devices including cell phones. Meanwhile, GPS receivers capable of receiving data from the GPS have gradually become smaller. A GPS receiver triangulates its current position by comparing a time that a signal is transmitted from GPS satellites until it is received by a receiver on Earth. A typical GPS receiver locks on to the signal of at least three satellites to receive a two-dimensional position on the earth (latitude and longitude) and that locks on to the signal of four or more satellites to determine a three-dimensional position on the earth (latitude, longitude and altitude).

It has also been known to use transmitting devices for locating arrows used by game hunters. Known prior art devices are disclosed in the following U.S. Pat. Nos. 4,421,319; 4,675,683; 6,856,250 and 4,704,612. It will be noted that each of these patents discloses a transmitting device which is constructed in combination with a hunter's arrow, i.e., the transmitting device is fixedly secured to the arrow in each of the above disclosures. This feature is a disadvantage since certain modern hunters' bows have the power to drive an arrow entirely through the body of an animal. Accordingly, the known prior art is unable to track an animal wounded by an arrow carrying a transmitting device but which passes through its body.

Thus, there is a need for an effective, reliable device that can be used to help the hunter to track the game and reclaim the arrow by providing the direction and location of the arrow with or without internet services.

### SUMMARY OF THE INVENTION

The object of the present invention to overcome the deficiencies of the prior art and to provide an improved game tracking arrow having a tracking device. As such, the general purpose of the present invention, which will be described subsequently in greater detail, is to provide a new and improved trackable hunting arrow and tracking system which has all the advantages of the prior art and none of the disadvantages.

The invention disclosed herein is a device and system by which an animal which has been shot by a bow hunter's arrow and who runs into the brush may be easily tracked and found. The invention provides a game tracking arrow that includes an arrowhead having a tail end, a hollow shaft having a forward end and a rear end, a nock having a front end configured at rear end of the hollow shaft and a back end configured to engage a bowstring, and a tracking device having a first end configured at tail end of the arrow head and a second end configured at forward end of the hollow shaft. Further, the tracking device is adapted to transmit a tracking signal to a receiving device via wireless communication such as satellite communication, internet, Wide area network (WAN), telecommunications network and the like.

It is another object of the present invention to provide an arrow tracking system that includes an arrow having an arrowhead, a hollow shaft, a tracking device and a nock, wherein the tracking device is adapted to transmit a tracking signal. Further, the system includes a receiving device which is adapted to receive the tracking signal via wireless communication from the tracking device configured with the arrow. Further, the receiving device is configured to display a map showing a present location of the arrow based on the tracking signal.

It is another object of the present invention, the receiving device may be developed as a software program which may be downloaded onto any wireless electronic device that will allow software applications downloads.

It is another object of the present invention, the system is adapted to calculate a distance from the receiving device carried by the hunter to the arrow based on the current position of receiving device and the current position of arrow by using GPS coordinates retrieved from the receiving device and tracking device attached to the arrow and displays directions to the arrow on a map on receiving device.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1. Illustrate an assembly view of the hunting arrow having a tracking device according to the present invention.

FIG. 2 illustrates a tracking system for detecting the location of a hunting arrow or animal wounded by the arrow, according to the present invention

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

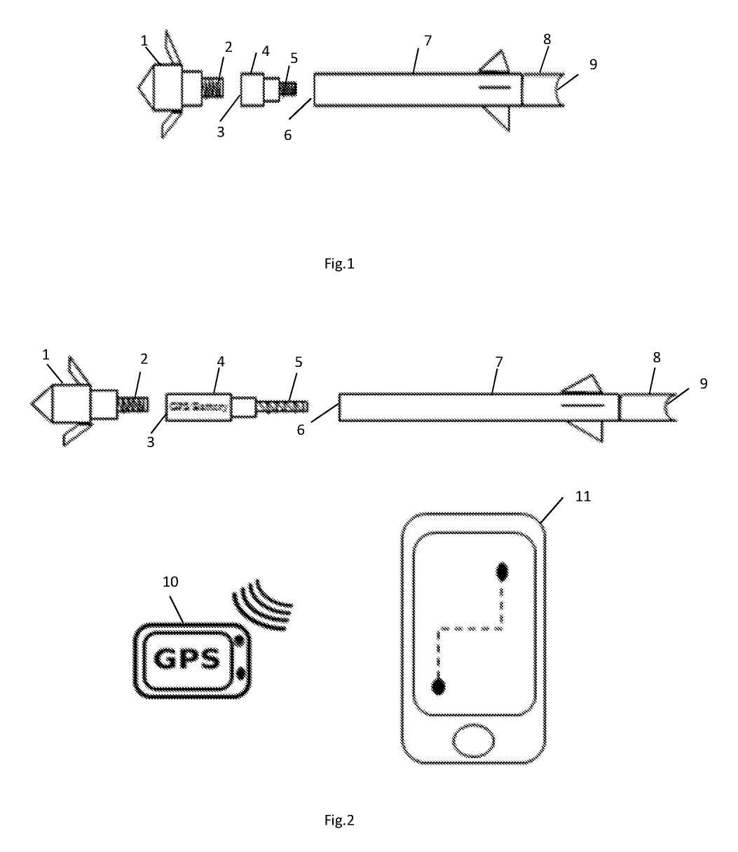

Now Referring to FIG. 1, there is shown a game tracking arrow. Further, the game tracking arrow includes an arrowhead 1 having a tail end 2 which includes an external thread, a hollow shaft 7 having a forward end 6 and a rear end (not shown). Further, the forward end 6 and a rear end (not shown) of the hollow shaft includes internal thread inside the inner wall of the hollow shaft 7. Further, the game tracking arrow includes a nock 8 having a front end having external threads extend from the nock 8 (not shown) and a back end 9 configured to engage a bowstring (not shown). Further the game tracking arrow includes a tracking device 4 having a first end 3 which includes internal thread inside the inner wall of the a tracking device 4 and a second end 5 having external threads extend from the second end 5.

Further, in one embodiment of the present invention, the arrow head 1, the tracking device 4, the hollow shaft 7 and the nock 8 are connected via a threaded connection that directly connects the arrow head 1, the hollow shaft 7, the nock 8 and the tracking device 4, Further, the tail end 2 of the arrow head 1 and the second end 5 of the tracking device includes a male or external thread which is adapted to rotatively engage into the first end 3 of the tracking device and the forward end 5 of the hollow shaft respectively.

In one embodiment of the present invention, the nock 8 is comprised of a light-weight polymeric material, such as nylon. Further, such material would also preferably be transparent to enable the user to see that the components have been properly placed within the chamber and the arrow is ready for use.

In an another embodiment of the present invention, the tracking device 4 is adapted to transmit a tracking signal to a receiving device 11 via wireless communication such as satellite communication, internet, Wide area network (WAN), telecommunications network and the like. Further, In an exemplary embodiment, the tracking device 4 is removably attached to the arrow. In an exemplary embodiment, the tracking device 4 may be any device capable of transmitting a wireless signal or tracking signal. Further, the tracking device 4 is a GPS chip or GPS transmitter. In another embodiment, the tracking device 4 may be a radio pulse device. The radio pulse device may be any device which uses radio waves to determine a location, range, altitude, direction and/or speed of an object. In yet another embodiment, the tracking device 4 may be a GSM/GPRS tracking device.

In an another embodiment of the present invention, the tracking device 4 is adapted to connect with the global positioning system (“GPS”) satellites and receiving device 11 via wireless communication such as satellite communication, internet, Wide area network (WAN), telecommunications network and the like. The tracking device 4 includes a GPS unit for determining the location coordinates of the arrow and circuitry that facilitate wireless communication with a receiving device 11 (i.e., a mobile wireless handheld device, a Wireless Application Protocol (WAP) device, a personal digital assistant, a stand alone GPS locator 10, a software application running on a processor and a portable computer having wireless connectivity).

Further, in an another embodiment of the present invention, the tracking device 4, once configured with an arrow, is in an “active” state and sends signals to the receiving device 11. Further, the tracking device 4 includes rechargeable battery attached to the tracking device in detachable manner. Preferably, the battery would have a high power, be light in weight, be rechargeable, and have a long transmitting life. Further, the battery is either a nickel-cadmium (NiCd), lithium ion, and neodymium batteries. Additionally, less expensive AA batteries may be used.

In one embodiment of the present invention, the tracking device herein is usable with almost all of hunting arrows.

Now referring to FIG. 2, there is shown an arrow tracking system that includes an arrow having an arrowhead 1, a hollow shaft 7, a tracking device 4 and a nock 8. Further, the tracking device 4 is adapted to transmit a tracking signal. Further, the system includes a receiving device 11 which is adapted to receive the tracking signal via wireless communication (i.e. satellite communication, internet, Wide area network (WAN), telecommunication network and the like) from the tracking device 4 configured with the arrow.

Further, the receiving device 10 is adapted to display a map showing a present location of the arrow based on the tracking signal received from the tracking device, wherein the tracking signal includes a GPS data, recorded location data, a current location, latitude, longitude, altitude, speed, and arrow striking information of the game tracking arrow over the wireless communication from the tracking device. Further, in one embodiment, the tracking device 4 is a radio transmitter-receiver device which is adapted to transmit identifiable signals and a location information signal automatically when the proper interrogation is received from the receiving device 11 remote thereto.

In one embodiment of the present invention, the tracking device 4 is adapted to calculate a distance from the receiving device to the arrow based on the current position of receiving device and the current position of arrow and displays directions to the arrow on a map on receiving device 4.

In another exemplary embodiment, when the game animal, injured by the bow hunter's arrow runs into the brush, the tracking device 4 configured with the arrow sends a tracking GPS signal which is detected by a receiving device carried by the bow hunter. The coordinates of the GPS signal received from the tracking device attached to the arrow may be plotted by the receiving device Further, the receiving device 11 is adapted to display the direction and location on the map to the hunter to locate the injured game animal or arrow.

In an another embodiment of the present invention, the receiving device is a GPS hand held locator 10, is enabled to receive the tracking signal from the tracking device attached to the arrow through direct GPS satellite communication in case of no internet connectivity. Further, the receiving device is adapted to display the location of the arrow on the map by using a software application.

In an another embodiment of the present invention, the receiving device may be developed as a software program which may be downloaded onto any wireless electronic device that will allow software applications downloads.

In another exemplary embodiment, the game tracking arrow may further include one or metal barbs. The metal barbs may be positioned between the arrowhead 1 and the tracking device 4. The game tracking arrow may further include a second set of metal barbs which may be located on a sliding ring (not shown) encircling the hollow shaft.

Further, the hollow shaft 7 of the game tracking arrow may be fashioned of any material that is flexible yet sturdy. The material of the hollow shaft 7 may also be weather resistant and water-proof. Materials of the hollow shaft 7 may include, but are not limited to lightweight wood, bamboo, reeds, aluminum, stainless steel, fiberglass, carbon fiber reinforced polymer, plastics or composite materials including an aluminum core wrapped with a carbon fiber exterior

In another exemplary embodiment, a user may shoot the game tracking arrow of the present embodiments from any type of bow device, including but not limited to a crossbow, a regular compound bow, or mechanical bow device. The game tracking arrow may vary in length depending on the type of bow used. For example, game tracking arrow used by a crossbow may be between eighteen and twenty-two inches, whereas a game tracking arrow used by a regular compound bow may be longer.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A game tracking arrow comprising:
an arrowhead having a tail end, the tail end having an external thread;
a hollow shaft having a forward end and a rear end, the forward end and the rear end having internal threads;
a nock having a front end, the front end having an external thread; and
an attachable/detachable tracking device having a first end and a second end, the first end having an internal thread and the second end having an external thread; wherein the internal thread of the first end of the tracking device is rotatably attachable to the external thread of the arrowhead tail end,
the external thread of the second end of the tracking device is rotatably attachable to the internal thread of the forward end of the hollow shaft, and
the internal thread of the rear end of the hollow shaft is attachable to the external thread of the front end of the nock; and wherein
the tracking device is a Global Positioning System (GPS) chip or transmitter, said chip or transmitter being in active state and adapted to transmit a tracking signal to a receiving device via wireless communication when attached to the tracking arrow.

2. (canceled)

3. (canceled)

4. (canceled)

5. (canceled)

6. The game tracking arrow of claim 1, wherein the tracking device includes a battery which is removably attached to the tracking device.

7. The game tracking arrow of claim 6, wherein the battery is a rechargeable battery.

8. The game tracking arrow according to claim 1, wherein the receiving device is adapted to calculate a distance from the receiving device to the arrow based on position of the receiving device and position of the arrow and the receiving device displays directions to the arrow on a map displayed on the receiving device.

9. The game tracking arrow device according to claim 1, wherein the receiving device is a mobile wireless handheld device, a Wireless Application Protocol (WAP) device, a personal digital assistant, a stand alone GPS locator, a software application running on a processor and a portable computer having wireless connectivity.

10. The game tracking arrow according to claim 1, wherein the receiving device is a GPS enabled device which is adapted to transmit and receive GPS signal.

11. The game tracking arrow according to claim 1, wherein the receiving device is adapted to receive tracking signal from the tracking device configured with the arrow through direct satellite communication in case of no internet connectivity.

12. The game tracking arrow according to claim 1, wherein the tracking signal includes a GPS data, recorded location data, a current location, latitude, longitude, altitude, speed, and arrow striking information of the game tracking arrow over the wireless communication from the tracking device.

13. An arrow tracking system comprising:
an arrow consisting of an arrowhead, a hollow shaft,
a tracking device rotatably attachable/detachable via threaded connections from its first end to the arrowhead and from its second end to a front end of the hollow shaft, and a nock attached to a rear end of the hollow shaft,
wherein the tracking device is a global positioning system (GPS) or GPS chip and is active and adapted to transmit a tracking signal when attached to the arrowhead and the shaft; and
a receiving device which is adapted to receive a tracking signal via wireless communication from the tracking device configured with the arrow,
wherein the receiving device is configured to display a map showing a present location of the arrow based on the tracking signal.

14. (canceled)

15. The arrow tracking system according to claim 13, wherein the receiving device is a mobile wireless handheld device, a Wireless Application Protocol (WAP) device, a personal digital assistant, a stand alone GPS locator, a software application running on a processor and a portable computer having wireless connectivity.

16. (canceled)

17. (canceled)

18. The arrow tracking system according to claim 13, wherein the tracking device is adapted to calculate a distance from the receiving device to the said arrow based on current position of the receiving device and the current position of the arrow and displays directions to the arrow on a map on said receiving device.

19. The arrow tracking system according to claim 13, wherein the receiving device is a GPS enabled device which is adapted to transmit and receive GPS signal.

20. The arrow tracking system according to claim 13, wherein the receiving device is adapted to receive tracking signal from the tracking device configured with the arrow through direct satellite communication in case of no internet connectivity.

21. The arrow tracking system according to claim 13, wherein the tracking signal includes a GPS data, recorded location data, a current location, latitude, longitude, altitude, speed, and arrow striking information of the arrow over the wireless communication from the tracking device.
